(19) United States
(12) Patent Application Publication
(10) Pub. No.: US 2010/0080753 A1
(43) Pub. Date: Apr. 1, 2010

(54) SELF-STARTED PROCESS FOR HYDROGEN PRODUCTION

(76) Inventors: Yuh-Jeen HUANG, Hsinchu (TW); Chuin-Tih Yeh, Hsinchu (TW); Tsui-Wei Wang, Hsinchu (TW); Liang-Chor Chung, Hsinchu (TW)

Correspondence Address: Muncy, Geissler, Olds & Lowe, PLLC, P.O. BOX 1364, FAIRFAX, VA, 22038-1364, US

(21) Appl. No.: 12/394,950

(22) Filed: Feb. 27, 2009

(30) Foreign Application Priority Data
Sep. 26, 2008 (TW) 97137058

(51) Int. Cl. C01B 3/22; B01J 23/10

(52) U.S. Cl. 423/648.1; 502/304

(57) ABSTRACT

A self-started process for hydrogen production, which comprises following steps: providing a gas mixture having a methanol/oxygen molar ratio less than or equal to 0.6; and conducting the gas mixture to flow through a Cu/ZnO-based catalyst bed. The Cu/ZnO-based catalyst contains copper, zinc oxide, aluminum oxide, manganese oxide and/or cerium oxide. The Cu/ZnO-based catalyst can initiate the POM reaction; then, the gas mixture will rise to a temperature of over 120° C., and the POM reaction generates a HRG at a reaction temperature of less than or equal to 180° C. The HRG contains less than 4 vol. % CO, and the POM reaction generates 1.8 moles hydrogen or more per 1 mole methanol consumed.

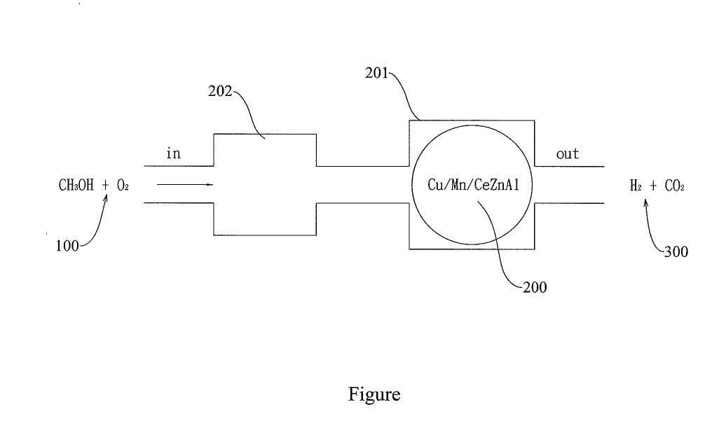

### BACKGROUND OF THE INVENTION

1. Field of the Invention

The present invention relates to a hydrogen production process, more particularly to a hydrogen production process initiated at room temperature and producing hydrogen at low temperature.

2. Description of the Related Art

Fuel cells capable of converting chemical energy of the fuel into electricity and also satisfying the requirement of environmental protection are now being continuously developed. Proton exchange membrane fuel cells (PEMFCs) take advantage of lower operation temperature and are of great potential among those developing fuel cells. However, PEMFCs have disadvantages in storage and transportation of hydrogen. Hydrocarbon molecules are used as the external primary fuel in PEMFCs and converted into hydrogen rich gas (HRG) on site. HRG is gas mixture with high hydrogen content and one of environmentally friendly fuels applied in fuel cells.

Production of HRG from reforming of methanol has been widely studied because of being highly chemically active, abundant, and cheap. Many methanol reforming processes have been developed and published in literatures, including (1) “methanol decomposition” (MD) process, (2) “steam reforming of methanol” (SRM) process and (3) “partial oxidation of methanol” (POM) process, which may be expressed by the following chemical formulas.

CH₃OH→2H₂+CO ΔH=90.1 kJmol⁻¹ (1)

CH₃OH+H₂O→3H₂+CO₂ ΔH=49 kJmol⁻¹ (2)

CH₃OH+1/2 O₂→2H₂+CO₂ ΔH=−192 kJ mol⁻¹ (3)

CO is not only one main product generated in the MD process but also a contaminant for the platinum electrodes of the fuel cells. SRM process has high hydrogen yield (number of hydrogen molecule produced per each methanol molecule consumed) of R_{H2}=3.0. However, SRM process is an endothermic reaction which is not theoretically favored at low temperatures according to Le Chatelier's Principle and tends to be efficient at high temperature (>250° C.).

POM process is another known process for hydrogen production process in literatures. Different from SRM process, the POM process is an exothermic reaction. Once reaching the initiation temperature, the POM process will persist autonomously without external heat energy. Therefore, the POM process consumes less energy and requires a smaller reactor and a lower cost.

There have been many researches about catalysts for the POM process. For example, catalysts containing Cu, Zn, Ce, Zr, and Pd are disclosed in a US patent of publication No. 20070269367 by Wolf et al. The aforementioned catalysts need a higher temperature (>200° C.) to attain a better catalytic activity for the POM reaction. Further, a carbon monoxide (CO) selection ratio for the aforementioned reaction is as high as about 10%, and high CO content in the HRG will poison the platinum catalyst in PEMFCs, abruptly impair the catalytic function and thus lower the performance of PEMFCs. The performances of POM catalysts adopted in the following papers are listed in Table. 1, including Pd/ZnO (M. L. Cubeiro, J. L. G. Fierro, Appl. Catal. A 168 (1998) 307), Cu/ZnO (T. Bunluesin, R. J. Gorte, G. W. Graham, Appl. Catal. B 14 (1997) 105), Cu/ZnO—Al₂O₃ (S. Velu, K. Suzuki, T. Osaki, Catal. Lett. 62 (1999) 159, US patent of publication No. 20050002858), Cu/Cr—ZnO (Z. F. Wang, J. Y Xi, W. P. Wang, G. X. Lu, J. Mol. Catal. A: Chemical 191 (2003) 123), and CuPd/ZrO₂—ZnO (S. Schuyten, E. E. Wolf., Catal. Lett. 106 (2006) 7, US patent of publication No. 20070269367).

TABLE 1
Effects of Catalysts on the POM Reaction

| | Temperature | C_{MeOH} | S_{H2} | S_{CO} |
|---|---|---|---|---|
| Catalyst | (° C.) | (%) | (%) | (%) |
| Pd/ZnO | 250 | 70 | 96 | 19 |
| Cu/ZnO | 320 | 78 | 98 | 10 |
| Cu/ZnO—Al₂O₃ | 245 | 83 | 98 | 12 |
| Cu/Cr—ZnO | 200 | 86 | 68 | 12 |
| CuPd/ZrO₂—ZnO | 200 | 89 | 88 | 11 |

According to Table. 1, these catalysts share a common drawback in catalytic effect on the POM reaction that they could only have good catalytic activity in conditions of higher temperature (>220° C.).

As all the Cu and Pd containing catalysts in the cited papers need a reaction temperature over 200° C., the POM process needs a step of pre-heating and start-up, which is likely a bottleneck for initiation time. PEMFCs and reduces the practicability of PEMFCs. Once the initiation temperature and reaction temperature of the POM process are lowered, the start-up time of PEMFC, electric vehicles and electronic products would be shortened. Furthermore, the power consumption and cost thereof would also be reduced.

### SUMMARY OF THE INVENTION

One objective of the present invention is to provide a self-started process for hydrogen production at low temperature, wherein a partial oxidization of methanol (POM) process can be initiated at a room temperature without pre-heating and then undertaken at a reaction temperature of 180° C. or below, and wherein POM process not only generates hydrogen rich gas (HRG) containing 4% CO or less but also generates 1.8 moles hydrogen or more per 1 mole methanol consumed.

Another objective of the present invention is to provide a self-started process for hydrogen production at low temperature and use a low-cost Cu/ZnO-based catalyst to produce a low-CO HRG for fuel cells, wherein the low-CO HRG causes less contamination to the platinum electrodes of the fuel cells.

A further objective of the present invention is to provide a self-started process for hydrogen production at low temperature, wherein a Cu/ZnO-based catalyst is used to catalyze and initiate the POM process at a room temperature, and then the temperature is raised by the POM process.

To achieve the abovementioned objectives, one embodiment of the present invention proposes a self-started process for hydrogen production at low temperature, which comprises steps: providing a gas mixture comprising methanol and oxygen; conducting the gas mixture to flow through a Cu/ZnO-based catalyst, wherein the Cu/ZnO-based catalyst contains at least one of cerium oxide, manganese oxide and aluminum oxide; catalyzing and initiating a partial oxidization of methanol (POM) process wherein the POM process supplies heat energy itself and makes the gas mixture reach a temperature over 120° C. within 2 minutes; and generating a hydrogen rich gas (HRG) at a reaction temperature less than or equal to 180° C., wherein HRG contains less than or equal to 4 vol. % CO, and the POM process generates 1.8 moles hydrogen or more per 1 mole methanol consumed.

Another embodiment of the present invention proposes a catalyst for a self-started process for hydrogen production at low temperature, including a Cu/ZnO-based catalyst containing at least one of cerium oxide, manganese oxide and aluminum oxide. The Cu/ZnO-based catalyst of the present invention preferably contains 20.0-40.0 wt % copper, 10.0-70.0 wt % manganese oxide, 10.0-50.0 wt % aluminum oxide, and 40.0-70.0 wt % cerium oxide.

### BRIEF DESCRIPTION OF THE DRAWINGS

FIGURE is a diagram schematically illustrating a POM process according to one embodiment of the present invention.

### DETAILED DESCRIPTION OF THE INVENTION

A catalyst is a substance capable of reducing reaction temperature of processes and controlling the selectivity ratio for products; therefore, a good catalyst allows lower reaction temperature for a process. Finding an appropriate catalyst has been an important task in chemical process development. A self-started process for hydrogen production at low temperature of the present invention adopts a Cu/ZnO-based catalyst, which is low-cost and has high oxidizing/reducing capability. Further, the non-combustion type catalyst of the present invention can lower the reaction temperature of the POM process.

### Method for Catalyst Preparation

Cu/ZnO, Cu/MnO, Cu/MnZnOAl, Cu/CeZnO, Cu/CeO₂ catalysts adopted in the present invention are prepared with a co-precipitation method. In one embodiment, a 2M sodium bicarbonate (NaHCO₃) aqueous solution is added into an aqueous solution containing mixture of copper nitrate (Cu(NO₃)₂), cerium nitrate(Ce(NO₃)₄), aluminum nitrate (Al(NO₃)₃) and zinc nitrate(Zn(NO₃)₂), and the precipitation pH value is controlled within 6-9 to form a blue-green precipitate. The precipitate is then calcined at a temperature of 400° C. to obtain a fresh Cu/MnₓAl_{y}ZnO-z or Cu/CeₓZnO-z catalyst, wherein x is the weight percentage of manganese oxide or cerium oxide, y is the weight percentage of aluminum oxide, and z is the precipitation pH value of the mixed aqueous solution. The prepared Cu/ZnO-based catalyst contains 5-50 wt % copper according to the abovementioned co-precipitation method.

### POM Process and Method for Testing Catalytic Reaction

Refer to FIGURE for a POM system according to the present invention. In fixed bed reactor 201, a 0.1 g reduced catalyst 200 (60˜80 mesh) is placed in a quartz tube (not shown in the drawing) with 4 mm inner diameter in which the catalyst is immobilized with silica wool.

With regard to reactants 100, an aqueous methanol is evaporated with a pre-heater at a flow rate controlled by a liquid pump. Each flow rate of oxygen and carrier gas (e.g. Ar) is respectively controlled by a flow mass controller. The oxygen, Ar, and the gas evaporated from the aqueous methanol are charged into a mixing chamber 202 and mixed homogeneously (6.1 vol. % O₂, 12.2 vol. % CH₃OH, 81.7 vol. % Ar; n_{O2}/n_{MeOH}=0.5) to obtain a mixture. The gas mixture is then conducted to flow through the catalyst bed in the reactor 201. Here, the oxygen may be provided with pure oxygen or air. The gas mixture containing methanol and oxygen and flowing through the Cu/ZnO-based catalyst catalyzes the POM reaction at the room temperature. After the reaction is initiated, the temperature of the gas mixture will be autothermal to over 120° C. within 2 minutes without external heat energy supplied. Hydrogen is then generated by the POM reaction at a temperature less than or equal to 180° C.

The reaction products 300 are subjected to a qualitative separation process via two GC (gas chromatography), in which the H₂ and CO are separated by a Molecular Sieve 5A chromatography column, and H₂O, CO₂, and CH₃OH are separated by a Porapak Q chromatography column, and a quantitative analysis carried out by a TCD (thermal conductivity detector).

After the quantitative analysis via TCD, a methanol conversion rate (C_{MeOH}), selectivity of hydrogen (S_{H2}) and CO selectivity (S_{CO}) are calculated as follows:

C_{MeOH}=(n_{MeOH,in}−n_{MeOH,out})/n_{MeOH,in}×100%

S_{H2}=n_{H2}/(n_{H2}+n_{H2O})×100%

S_{CO}=n_{CO}/(n_{CO2}+n_{CO})×100%

A higher C_{MeOH} in the POM process represents the higher amount of reacted methanol in the whole process. The hydrogen may be generated from the POM process as well as oxidized with the oxygen in the reacting gases; therefore, a higher S_{H2} represents less hydrogen oxidized and less water generated after POM reaction. A higher S_{CO} represents that the carbon in the methanol is more likely desorbed in way of CO after the methanol is dehydrogenated; that is to say a less selectivity of CO₂.

Followings are the effects of catalysts containing Cu/MnZnO, Cu/MnZnAl and Cu/CeZnO on the POM reaction.

### Effect of Manganese Oxide Content

Table.2 shows the effect of manganese oxide content in Cu/MnO and Cu/MnZnOAl catalysts in the POM reaction. Although a catalyst containing only manganese oxide (Mn₂₀ZnO) has less catalytic activity, and a catalyst containing only copper (30% Cu/ZnO) is unable to initiate the POM reaction at room temperature. However, in the presence of manganese oxide, catalysts can initiate the reaction at a room temperature, and heat the system to reach a temperature over 120° C. within 2 minutes.

TABLE 2
Effect of Manganese Oxide Content in Cu/MnZnO and
Cu/MnZnOA 1 Catalysts on the POM Reaction

| | Initiation | | | | |
|---|---|---|---|---|---|
| | Tem- | Reaction | | | |
| | perature | Temperature | C_{MeOH} | S_{H2} | S_{CO} |
| Catalyst | (° C.) | (° C.) | (%) | (%) | (%) |
| Mn₂₀ZnO | RT | 180 | 70 | 74 | 8 |
| 30% Cu/ZnO | 140 | 180 | 90 | 88 | 8 |
| 30% Cu/Mn₇₀ | RT | 180 | 74 | 68 | 11 |
| 30% Cu/Mn₁₀ZnO | RT | 180 | 94 | 85 | 9 |
| 30% Cu/Mn₂₀ZnO | RT | 180 | 97 | 80 | 8.6 |
| 30% Cu/Mn₁₀ZnOAl₁₀ | RT | 180 | 95 | 81 | 8 |
| 30% Cu/Mn₂₀ZnOAl₂₀ | RT | 180 | 87 | 87 | 10 |

Meanwhile, the hydrogen could be generated at a temperature less than or equal to 180° C. The higher the manganese oxide content, the better catalyst activity and lower S_{CO} will be at lower temperature. However, S_{H2} slightly decreases with the increasing manganese oxide since redundant manganese oxide makes the generated hydrogen more likely to react with oxygen. Thus, the appropriate manganese oxide content is between 10 and 70 wt %. According to Table.2, redundant aluminum oxide content results in lower catalytic activity of catalysts containing aluminum oxide. Thus, the appropriate aluminum oxide content is between 10 and 30 wt %.

### Effect of Cerium Oxide Content

Table.3 shows the effect of cerium oxide content in Cu/CeZnO catalysts on the POM reaction. According to Table.3, the initiation temperature decreases with the increasing cerium oxide content. Especially, when the cerium oxide content is over 40 wt %, the reaction can be initiated at a room temperature, and the temperature of the POM process will reach 120° C. and over within two minutes. However, S_{H2} and C_{MeOH} slightly decrease with the increasing cerium oxide because redundant cerium oxide content (70 wt %) makes hydrogen more likely to react with oxygen. Thus, the appropriate cerium oxide content is between 40 and 70 wt %.

TABLE 3
Effect of Cerium Oxide Content in Cu/CeZnO
Catalyst on the POM Reaction

| | Initiation | Reaction | | | |
|---|---|---|---|---|---|
| | Temperature | Temperature | C_{MeOH} | S_{H2} | S_{CO} |
| Catalyst | (° C.) | (° C.) | (%) | (%) | (%) |
| 30% Cu/ZnO-7 | 200 | 225 | 95 | 91 | 13 |
| 30% Cu/Ce₂₀ZnO-7 | 180 | 200 | 97 | 92 | 11 |
| 30% Cu/Ce₄₀ZnO-7 | RT | 180 | 95 | 90 | 13 |
| 30% Cu/CeO₂-7 | RT | 180 | 93 | 86 | 18 |
| 30% Cu/Ce₄₀ZnO-7 | RT | 120 | 86 | 89 | 8 |
| 30% Cu/CeO₂-7 | RT | 120 | 82 | 84 | 9 |

### Effect of Copper Content

Table.4 shows the effect of copper content in Cu/CeZnO catalysts on the POM reaction. Cu/CeZnO catalysts with about 30 wt % copper content have shown the greatest catalytic activity due to larger surface area of metal copper. Thus, the appropriate copper content is between 20 and 40 wt %.

TABLE 4
Effect of Copper Content in Cu/CeZnO Catalysts on the POM
Reaction

| | Reaction | | | |
|---|---|---|---|---|
| | Temperature | | | |
| Catalyst | (° C.) | C_{MeOH} (%) | S_{H2} (%) | S_{CO} (%) |
| 10% Cu/Ce₄₀ZnO-7 | 200 | 81 | 84 | 6 |
| 30% Cu/Ce₄₀ZnO-7 | 200 | 97 | 90 | 14 |
| 50% Cu/Ce₄₀ZnO-7 | 200 | 71 | 85 | 4 |

### Effect of Precipitation pH Value

Table.5 shows the effect of precipitation pH value for the sodium bicarbonate-precipitated Cu/CeZnO catalyst on the POM reaction. According to Table.5, the Cu/CeZnO catalysts have the greatest catalytic activity at a precipitation pH value of 6-7. The catalytic activity of the Cu/CeZnO catalyst decreases as the precipitation pH value rises since a higher pH value converts blue carbonate precipitate into black precipitate of copper oxide and hence increases the size of copper particles. Thus, the appropriate precipitation pH value is between 6 and 9.

TABLE 5
Effect of pH Value for Sodium
Bicarbonate-Precipitated Cu/CeZnO Catalyst on the POM Reaction

| | Reaction | | | |
|---|---|---|---|---|
| | Temperature | | | |
| Catalyst | (° C.) | C_{MeOH} (%) | S_{H2} (%) | S_{CO} (%) |
| 30% Cu/Ce₄₀ZnO-6 | 200 | 95 | 90 | 13 |
| 30% Cu/Ce₄₀ZnO-7 | 200 | 97 | 90 | 14 |
| 30% Cu/Ce₄₀ZnO-9 | 200 | 86 | 89 | 10 |

From the above description, the exemplary Cu/MnZnO catalysts or Cu/CeZnO catalysts play an important role in initiating the POM reaction at room temperature and produce hydrogen at low temperature. The POM reaction can be initiated at a room temperature by adopting the Cu/ZnO-based catalyst, and the POM reaction can heat to reach a temperature of over 120° C. The POM reaction then generates HRG with low-CO contamination and high hydrogen-yield at a temperature less than or equal to 180° C., wherein the CO concentration is less than or equal to 4 vol. %. The present invention may cause impact on the development of petroleum industry, fuel cell technology, and hydrogen economic since PEMFCs (Proton Exchange Membrane Fuel Cell) have now been regarded as a very potential power source for notebook computers, mobile phones and digital cameras. The self-started POM process catalyzed by catalysts of this present invention is of high hydrogen yield and may be applied to PEMFC.

In conclusion, the present invention proposes a self-started process for hydrogen production at low temperature, which comprises following steps: providing a gas mixture with a methanol/oxygen molar ratio less than or equal to 0.6; and conducting the gas mixture to flow through a Cu/ZnO-based catalyst and initiate the POM reaction at room temperature, wherein the gas mixture reaches a temperature of over 120° C. within 2 minutes, and the POM reaction then generates HRG at a reaction temperature less than or equal to 180° C., and wherein the HRG contains less than 4 vol. % of CO, and the POM reaction can generate 1.8 moles hydrogen or more per 1 mole of methanol consumed, and wherein the Cu/ZnO-based catalyst contains copper, cerium oxide, manganese oxide, zinc oxide, aluminum oxide, etc.

The self-started process for hydrogen production of the present invention adopts a Cu/ZnO-based catalyst, which contains at least one of cerium oxide, manganese oxide and aluminum oxide. Preferably, the Cu/ZnO-based catalyst of the present invention contains 20.0-40.0 wt % copper, 10.0-70.0 wt % manganese oxide, 10.0-50.0 wt % aluminum oxide, and 40.0-70.0 wt % cerium oxide.

The embodiments described above are to demonstrate the technical thoughts and characteristics of the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A self-started process for hydrogen production comprising
providing a gas mixture comprising methanol and oxygen;
conducting the gas mixture to flow through a Cu/ZnO-based catalyst, wherein the Cu/ZnO-based catalyst contains at least one of cerium oxide, manganese oxide and aluminum oxide;
catalyzing and initiating a partial oxidization of methanol (POM) process, wherein the POM process supplies heat energy itself and makes the gas mixture reach a temperature over 120° C. within 2 minutes; and
generating a hydrogen rich gas (HRG) at a reaction temperature less than or equal to 180° C., wherein the HRG contains less than or equal to 4 vol. % CO, and the POM process generates 1.8 moles hydrogen or more per 1 mole methanol consumed.

2. The self-started process for hydrogen production according to claim 1, wherein no external heat is required for initiating the POM process.

3. The self-started process for hydrogen production according to claim 1, wherein the oxygen is provided with pure oxygen or air.

4. The self-started process for hydrogen production according to claim 1, wherein the gas mixture has a methanol/oxygen molar ratio less than or equal to about 0.6.

5. The self-started process for hydrogen production according to claim 1, wherein the Cu/ZnO-based catalyst contains 20.0-40.0 wt % copper.

6. The self-started process for hydrogen production according to claim 1, wherein the Cu/ZnO-based catalyst contains 10.0-70.0 wt % manganese oxide.

7. The self-started process for hydrogen production according to claim 1, wherein the Cu/ZnO-based catalyst contains 10.0-50.0 wt % aluminum oxide.

8. The self-started process for hydrogen production according to claim 1, wherein the Cu/ZnO-based catalyst contains 40.0-70.0 wt % cerium oxide.

9. The self-started process for hydrogen production according to claim 1, wherein the Cu/ZnO-based catalyst is prepared with a co-precipitation method.

10. The self-started process for hydrogen production according to claim 9, wherein an aqueous solution of sodium bicarbonate (NaHCO₃) is applied as a precipitation agent during co-precipitation.

11. The self-started process for hydrogen production according to claim 9, wherein the co-precipitation method is processed at a precipitation pH value within 6-9.

12. A catalyst for a self-started process for hydrogen production, comprising a Cu/ZnO-based catalyst containing at least one of cerium oxide, manganese oxide and aluminum oxide, wherein the Cu/ZnO-based catalyst preferably comprises 20.0-40.0 wt % copper, 10.0-70.0 wt % manganese oxide, 10.0-50.0 wt % aluminum oxide and 40.0-70.0 wt % cerium oxide.
